(19) United States
(12) Patent Application Publication
(10) Pub. No.: US 2023/0400154 A1
(43) Pub. Date: Dec. 14, 2023

(54) SYSTEMS AND METHODS FOR MIXING AND DISPENSING GAS AT A CONTROLLED TEMPERATURE USING CRYOGENIC FLUID

(71) Applicant: Plug Power Inc., Latham, NY (US)

(72) Inventors: Landon CORDOVA, Latham, NY (US); Stephan MOESSNER, Latham, NY (US); Allen ADRIANI, Latham, NY (US); Nikunj PATEL, Latham, NY (US)

(73) Assignee: Plug Power Inc., Latham, NY (US)

(21) Appl. No.: 18/333,055

(22) Filed: Jun. 12, 2023

Related U.S. Application Data
(60) Provisional application No. 63/366,176, filed on Jun. 10, 2022.

(51) Int. Cl. F17C 7/04

(52) U.S. Cl. CPC F17C 7/04; F17C 2223/0161; F17C 2265/065; F17C 2227/0393

(57) ABSTRACT

Aspects disclosed herein provide systems and methods for mixing and dispensing fuel. The method includes flowing cryogenic fuel from a storage tank through a cold portion of a process heat exchanger to a first vaporizer, flowing the cryogenic fuel from the first vaporizer through a warm portion of the process heat exchanger to obtain an intermediate temperature fuel exiting the process heat exchanger, and separating the intermediate temperature fuel into a first stream and a second stream. The method further includes directing the first stream through a second vaporizer to obtain a warm stream, combining the warm stream and the second stream to obtain a target fuel temperature stream, and dispensing the target fuel temperature stream through at least one dispenser.

### CROSS-REFERENCE TO RELATED APPLICATIONS

This application claims priority benefit under Section 35 U.S.C. § 119(e) of U.S. Provisional Application No. 63/366,176 filed Jun. 10, 2022, entitled, “METHOD FOR MIXING AND DISPENSING OF GAS AT A CONTROLLED TEMPERATURE USING CRYOGENIC FLUID”, which is incorporated herein by reference in its entirety.

This application is also related to U.S. Provisional Application No. 63/365,972 filed Jun. 7, 2022, entitled, “METHOD AND SYSTEM FOR DISPENSING CRYOGENIC LIQUID FUEL AS A GAS AT CONTROLLED TEMPERATURE WITH SPLIT-STREAM HEAT EXCHANGE AND NON-CRYOGENIC MIXING”, which is incorporated herein by reference in its entirety.

### TECHNICAL FIELD

Aspects disclosed herein relate, generally, to controlling the temperature of dispensed hydrogen gas (and other fuels, such as Compressed Natural Gas) that is initially stored as cryogenic liquid, gas, or mixed gas/liquid. The flow and control schemes presented are applicable to fuel dispensing stations, fuel production plants, mobile fuel dispensing systems, and other areas. While the above description of the technical field represents a few areas of specific interest, it is not inclusive of all applications for this invention.

### BACKGROUND OF THE INVENTION

Cryogenic liquids, such as liquid hydrogen or other fuel sources (e.g., Liquified Natural Gas (LNG), etc.) commonly stored as cryogenic liquid, may be used as a fuel source for fuel cell dependent vehicles and devices in a variety of applications, such as to provide motive power to vehicles, to power stationary power plants, to provide heating or other electrical needs to homes, etc. All fuel cell powered devices require mechanisms for supplying fuel which is generally stored as cryogenic liquid. Cryogenic liquid hydrogen may be supplied from a local storage container, or from mobile or stationary fueling stations.

The general refueling process of hydrogen fuel powered vehicles and systems is to periodically refill a local storage container in the same way gasoline is periodically used to refill the local storage containers in conventional internal combustion engine vehicles. For portable, mobile or stationary fueling stations, a local storage tank/vessel or a removeable/replaceable storage tank/vessel may be employed, these situations requiring cryogenic fuel be delivered to a portable, mobile or stationary fueling station and then stored until being delivered to another storage container or vehicle on board tank, fuel cell, or other hydrogen-consuming part of the fueling station itself.

Generally, hydrogen fueling stations utilize electrically powered refrigeration systems including heat exchangers to maintain consistent dispensing fuel temperatures by flowing cooled refrigerant through the heat exchanger in parallel to the hydrogen fuel at various points in the fueling system. Refrigerant systems may be physically large and may surround a portion of the cryogenic fuel source so as to constantly exchange heat and maintain system temperatures. Such systems may also be associated with high electricity costs. Refrigeration systems for cooling fuel may limit the number of stations or dispensers which may be employed at a stationary refueling site and the amount of fuel which may be transported in a mobile fueling station, ultimately limiting the number of vehicles which may effectively be fueled at one time or consecutively at any station.

Thus, a need exists for efficient systems and methods for controlling a temperature of hydrogen gas to be dispensed.

### SUMMARY OF THE INVENTION

The present invention provides, in a first aspect, a method for mixing and dispensing fuel. The method includes flowing cryogenic fuel from a storage tank through a cold portion of a process heat exchanger to a first vaporizer, flowing the cryogenic fuel from the first vaporizer through a warm portion of the process heat exchanger to obtain an intermediate temperature fuel exiting the process heat exchanger, and separating the intermediate temperature fuel into a first stream and a second stream. The method further includes directing the first stream through a second vaporizer to obtain a warm stream, combining the warm stream and the second stream to obtain a target fuel temperature stream, and dispensing the target fuel temperature stream through at least one dispenser.

The present invention provides, in a second aspect, a system for mixing and dispensing fuel, including a first temperature adjustment loop connected to a second temperature adjustment loop. The first temperature adjustment loop includes a storage tank configured to hold a fuel, a process heat exchanger located downstream from the storage tank and having a cold portion and a warm portion, and a first vaporizer having an inlet and an outlet, the inlet connected to the cold portion of the process heat exchanger and the outlet connected to the warm portion of the process heat exchanger. The second temperature adjustment loop includes a first flow path including a second vaporizer, and a second flow path bypassing the second vaporizer, the first flow path and second flow path connected downstream to a third flow path, the third flow path connected to at least one dispenser.

The present invention provides, in a third aspect, a system for mixing and dispensing fuel, including a first temperature adjustment loop connected to a second temperature adjustment loop. The first temperature adjustment loop includes a storage tank configured to hold a fuel, a process heat exchanger having a cold portion and a warm portion, a pump coupled to the storage tank and configured to pump fuel from the storage tank to the cold portion of the process heat exchanger, the cold portion of the process heat exchanger connected to an inlet of a first vaporizer, and the warm portion of the process heat exchanger connected to an outlet of the first vaporizer, the fuel passing from the cold portion of the process heat exchanger to the inlet of the first vaporizer, through the first vaporizer, and from the outlet of the first vaporizer to the warm portion of the process heat exchanger. The second temperature adjustment loop includes a control valve having a passage, the passage having a first opening and a second opening, the first opening coupled to the warm portion of the process heat exchanger and the second opening coupled to a first flow path and a second flow path, the control valve configured to separate the fuel received from the process heat exchanger into a first stream and a second stream, the control valve controllably permitting fuel from the first temperature adjustment loop to enter the second temperature adjustment loop, the first flow path including a second vaporizer, and the second flow path bypassing the second vaporizer, the first flow path and the second flow path connected to a mixing valve, the mixing valve located upstream from at least one dispenser, the mixing valve configured to receive and mix the fuel from the first flow path and the second flow path, and the dispenser configured to receive and dispense the fuel after the fuel has been mixed.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a schematic diagram view of one embodiment of a system for mixing and dispensing hydrogen fuel;

FIG. 2 is a schematic diagram view of a further embodiment of a system for mixing and dispensing hydrogen fuel;

FIG. 3 is a schematic diagram view of yet a further embodiment of a system for mixing and dispensing hydrogen fuel;

FIG. 4 is a schematic diagram view of yet a further embodiment of the system of a system for mixing and dispensing hydrogen fuel.

FIG. 5 is a schematic diagram view of a process recuperator heat exchanger of the system of FIG. 1.

### DETAILED DESCRIPTION OF THE INVENTION

Aspects will be discussed hereinafter in detail in terms of various exemplary embodiments according to the present invention with reference to the accompanying drawings. In following the detailed description, numerous specific details are set forth in order to provide a thorough understanding of the aspects. It will be obvious, however, to those skilled in the art that the aspects may be practiced without these specific details. In other instances, well-known structures are not shown in detail in order to avoid unnecessary obscuring of aspects.

Furthermore, there is no intention to be bound by any expressed or implied theory presented in the preceding technical field, background, brief summary, or the following detailed description. It is also understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In accordance with aspects disclosed herein, systems, and methods for mixing and dispensing fuel at a controlled temperature using cryogenic fluid are provided. Aspects of the systems and methods disclosed herein may control a target fuel dispensing temperature over an extensive range of typical ambient temperatures. The typical range is expected to be from −40° C. to +50° C., such as SAE J2601 fueling protocol for light duty hydrogen fueling. Aspects may be required to control the temperature of fuel at a point of dispensing to be within a specified control window, typically below ambient temperature (e.g., −40° C. to −33° C. for hydrogen, such as required by SAE J2601 fueling protocol for T40 fueling, or similar).

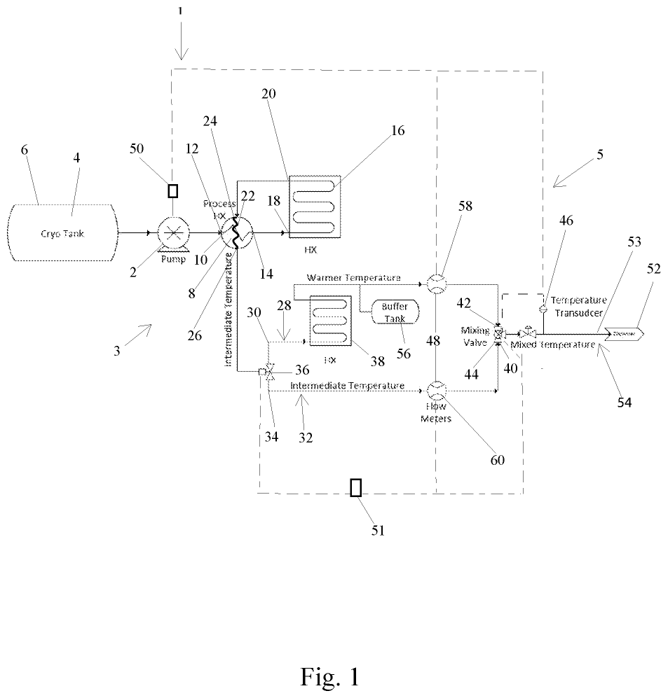

Referring now to FIG. 1, a system 1 for mixing and dispensing fuel may include a pump 2 configured to pass a process fluid or fuel 4 (e.g., cryogenic H₂, LNG, or other process fluid(s)/gas(ses)) from a storage vessel 6 (e.g., a cryogenic storage tank) through a first temperature conditioning loop 3 and a second temperature conditioning loop 5. Notably, aspects (e.g., portions of the first temperature conditioning loop 3 and the second temperature conditioning loop 5) of the system 1 described herein may be connected by various conduits (not shown) configured to hold and/or transfer the fuel 4 proceeding through the system 1. For example, the various conduits may include, inter alia, tubing and/or piping connecting the pump 2 to the storage vessel 6. The various conduits may connect and/or couple various components of the system 1, especially those components through which the fuel 4 may pass, as described in more detail below. While the conduits may not always be directly described, one skilled in the art would know and appreciate from the present disclosure where and how the various conduits may be located to facilitate the connections between various components of the system 1 described herein. For example, aspects of the present disclosure include various pathways along which the fuel 4 is to flow during operation of the system 1; these pathways (i.e., flow paths) described below may be formed by, and may depend on, at least in-part, the various conduits permitting fluid communication between components in the system 100, as described in more detail below.

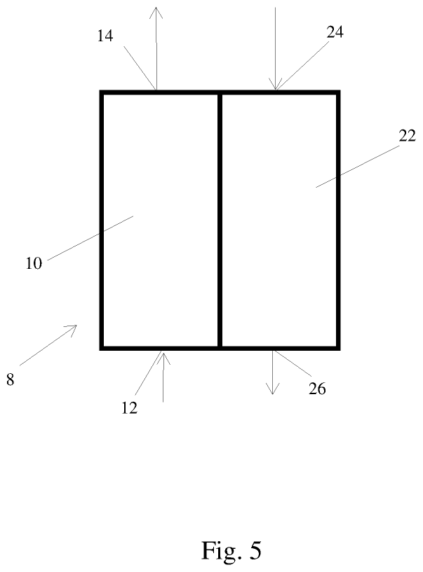

In the first temperature conditioning loop 3, the pump 2 may flow (i.e., pump) the fuel 4 to a process recuperator heat exchanger 8 (e.g., a process-process heat exchanger) as depicted in FIGS. 1 and 5. The process recuperator heat exchanger 8 includes two nonmixing portions or passages, a cold portion 10 and a warm portion 22, which may permit heat to transfer between the fuel 4 flowing through the cold portion 10 with the fuel 4 flowing through the warm portion 22. The process recuperator heat exchanger 8 permits the system 1 to raise a temperature of the fuel 4 in the first temperature conditioning loop 3 to above cryogenic temperatures before the fuel 4 proceeds to the second temperature adjustment loop 5, which may provide advantages as described in more detail below.

The pump 2 may flow (i.e., pump) the fuel 4 (e.g., via a conduit) to a cold portion inlet 12 of the cold portion 10 of the process recuperator heat exchanger 8 (e.g., a process-process heat exchanger) as depicted in FIG. 1. A cold portion outlet 14 of the cold portion 10 of the process recuperator heat exchanger 8 may feed a first vaporizer 16. As the fuel 4 exits the cold portion outlet 14 the fuel 4 may flow (e.g., via a conduit) to an inlet 18 of the first vaporizer 16 and therethrough to an outlet 20 of the first vaporizer 16. In some embodiments, the first vaporizer 16 may be an ambient heat exchanger (i.e., a heat exchanger in which ambient air is used to control the fuel 4 temperature up to near ambient temperatures) or an electrically powered vaporizer. The ambient heat exchanger may be a natural draft ambient heat exchanger, a forced draft ambient heat exchanger, or otherwise depending on the requirements of the system on a case-by-case basis.

The fuel 4 may then exit the outlet 20 of the first vaporizer 16 towards a warm portion inlet 24 of a warm portion 22 of the process recuperator heat exchanger 8, where the fuel 4 exchanges thermal energy with the fuel 4 flowing through the cold portion 10 of the process recuperator heat exchanger 8, as shown in FIGS. 1 and 5. The fuel 4 then discharges from a warm portion outlet 26 of the warm portion 22 of the process recuperator heat exchanger 8 at a process temperature lower than a desired dispensing temperature (i.e., an “intermediate temperature”), completing the flow of the fuel 4 through the first temperature conditioning loop 3. This flow of the fuel 4 through the first temperature conditioning loop 3 may raise a temperature of the fuel 4 from a cryogenic storage temperature (e.g., −453° C.) to an intermediate temperature (e.g., −40° C. to −150° C.) which is less than a desired dispensing temperature (e.g., −40° to 0° F.). An advantage of the system 1 is that the design of the system 1, or more specifically, the design of the first temperature conditioning loop 3, is such that the temperature of all the fuel 4 in the system 1 is raised to above cryogenic temperatures early on in the process (e.g., prior to flowing through the second temperature conditioning loop 5), which reduces, mitigates, and/or eliminates the risk of flashing liquid, local volume expansion, and/or other complications present when mixing cryogenic fluid directly with warmer fluid.

As depicted in FIG. 1, after exiting from the warm portion outlet 26, the fuel 4 (e.g., now at the intermediate temperature) may flow (e.g., via a conduit) to the second temperature conditioning loop 5, where the fuel 4 may be separated into a first stream 28 (e.g., a “warm” stream) which is directed to and flows (e.g., via a conduit) along a first flow path 30 and a second stream 32 (e.g., an “intermediate temperature” stream) which is directed to and flows along a second flow path 34 (e.g., via a conduit). The flow scheme of the system 1 is uniquely configured such that the first temperature conditioning loop 3 may always have a same rate of flow in and/or out of both portions 10, 22, of the process recuperator heat exchanger 8. However, the system 1 may have a variable flow rate at different locations in the system 1 downstream (i.e., in a direction from tank 6 toward the at least one dispenser 52) from the first temperature conditioning loop 3 (e.g., in the second temperature conditioning loop 5), as is described in more detail below. In one embodiment, the proportioning of the fuel 4 between the first stream 28 and the second stream 32 may be achieved by one or more control valves 36. Note that a single three way-mixing valve, a manifold, a plurality of orifices, and/or a single control valve or a combination thereof may also be acceptable in place of the one or more control valves 36 to correctly proportion and direct the fuel 4 between the first stream 28 and the second stream 32. There may be other structure sufficient to correctly proportion the fuel 4 between the first stream 28 and the second stream 32 which one skilled in the art would appreciate and understand from the present disclosure.

Depending on ambient temperature and the temperature of the fuel 4 upon exiting the process recuperator heat exchanger 8, a flow split between the two streams may be adjusted (using either split action or single action valve control) either manually or automatically to achieve the desired dispensing temperature, as is be described in more detail below.

After being separated into the first stream 28 and the second stream 32, the first stream 28 (i.e., the “warm” stream) is then directed through a second vaporizer 38 (e.g., a natural draft, forced draft, or electrically heated vaporizer) to increase the temperature of the fuel 4 to a temperature that is near ambient temperature, as depicted in FIG. 1. The second stream 32 (i.e., the “intermediate temperature” stream) flows without intentional temperature modification in parallel to the first stream 28, that is, the second stream 32 bypasses the second vaporizer 38. The first stream 28 and the second stream 32 are then mixed in the appropriate proportions to obtain a target temperature fuel stream 54 (i.e., achieve the desired dispensing temperature of the fuel) before dispensing the fuel 4 (i.e., the target temperature fuel stream 54) from at least one dispenser 52. Changes in temperature (i.e., heat gains) which may occur beyond the point of mixing (i.e., after mixing and before being dispensed through the at least one dispenser 52) the fuel 4 to the desired dispensing temperature due to, e.g., ambient conditions, may be countered (i.e., compensated for) by targeting a lower mixed temperature.

As ambient temperatures decrease, the surface area of an ambient heat exchanger (i.e., vaporizer) required to maintain necessary approach temperatures (i.e., the necessary temperatures of the fuel 4 at various points in the system 1 prior to mixing/recombining) increases. Where ambient temperatures are cold, ambient natural draft or forced draft heat exchangers (i.e., vaporizers) may therefore not be practical to employ for the first vaporizer 16 and/or the second vaporizer 38 because the surface area required to properly heat the fuel 4 may be impractical or prohibitive (e.g., there isn't enough space which can be dedicated to a heat exchanger/vaporizer of the necessary size). For cold weather applications, steam or hot water heater water bath vaporizers (i.e., heat exchangers), natural gas direct fired water bath vaporizers (i.e., heat exchangers), electricity heated vaporizers (i.e., heat exchangers), or electric heater water bath vaporizers (i.e., heat exchangers) may be used for the first vaporizer 16 and/or second vaporizer 38 to control the temperatures and reduce the heat exchange surface area. These types of vaporizers may also be used to reduce an environmental footprint of the system 1. The first vaporizer 16 and/or second vaporizer 38 may therefore be replaced on a case-by-case basis as described above to, inter alia, reduce the system 1 footprint, reduce the impact of external disturbances (e.g., changes in ambient conditions), and/or to control the outlet temperature and/or the desired dispensing temperature of the fuel 4 more finely.

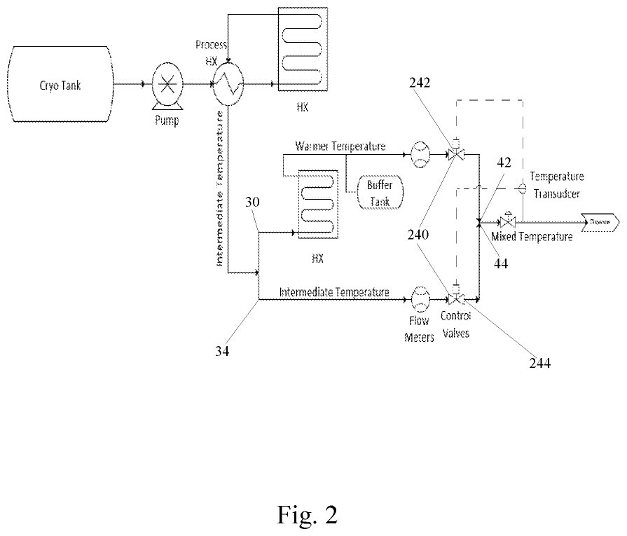

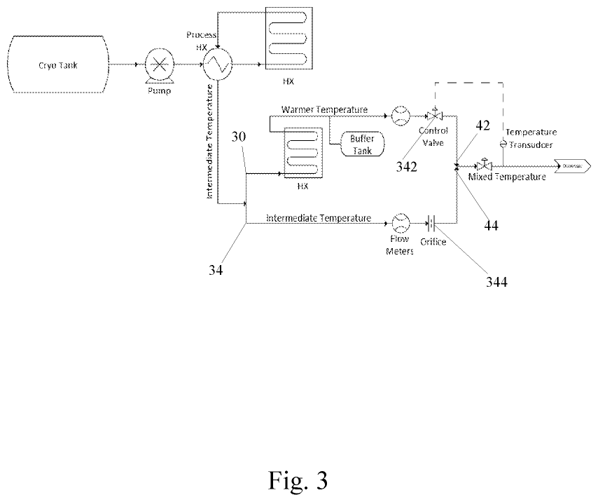

In some embodiments, the mixing of the fuel 4 (at different temperatures) from the first stream 28 and to the second stream 32 may be accomplished using one or more control valves, manifolds, and/or orifices or a combination thereof. In some embodiments, the one or more control valves, manifolds, and/or orifices may be a single three-way mixing valve 40 connected to a first terminal end 42 of the first flow path 30, a second terminal end 44 of the second flow path 34, and a terminal flow path 53, as can be seen in FIG. 1. In another embodiment depicted in FIG. 2, the one or more control valves, manifolds, and/or orifices may comprise two control valves 240, wherein the two control valves 240 comprise a first control valve 242 located in the first flow path 30 upstream (i.e., in a direction from the at least one dispenser 52 towards the tank 6) from the first terminal end 42, and a second control valve 244 located in the second flow path 34 upstream from the second terminal end 44, with all other features depicted in FIG. 2 remaining the same as in FIG. 1. In such an embodiment, the reverse may also be employed in which the first control valve 242 may be located in the second flow path 34 and the second control valve 244 may be located in the first flow path 30, again with all other features remaining the same as in FIG. 1. In yet another embodiment, the one or more control valves, manifolds, and/or orifices may comprise a first control valve 342 located in the first flow path 30 upstream from the first terminal end 42 and a first orifice or plurality of orifices 344 located in the second flow path 34 upstream from the second terminal end 44, as can be seen in FIG. 3, with all other features depicted in FIG. 3 remaining the same as in FIG. 1.

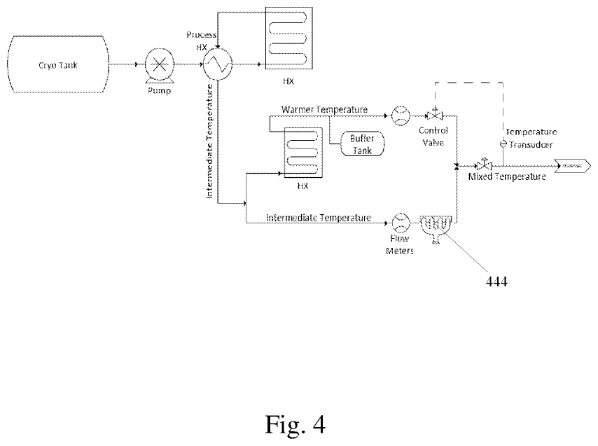

In another example depicted in FIG. 4, a first manifold 444 may be used in place of the first orifice or first plurality of orifices 344, with all other features depicted in FIG. 4 remaining the same as in FIG. 1. There may be other variations and/or combinations of control valves (e.g., three-way mixing valves or single control valves), manifolds, and/or orifices which may also be acceptable to correctly proportion the first stream 28 as it exits the first flow path 30 and the second stream 32 as it exits the second flow path 34 such that the first stream 28 and the second stream 32 are readily mixed to the desired dispensing temperature.

An advantage of the system 1 is that the design allows for increasing the temperature of the fuel 4 before mixing (specifically, in the first temperature conditioning loop 3) to above cryogenic temperatures. The reduction in temperature differential between the first stream 28 and the second steam 32 prior to recombination (i.e., mixing) of these streams reduces, mitigates, and/or eliminates the risk of flashing liquid or local volume expansion and/or contraction present when directly mixing a cryogenic fluid with an ambient temperature fluid which may create risks of explosion(s) and/or other forms of system failure, and/or which may damage equipment, and/or other circumstances which may cause the fuel 4 not to reach the desired dispensing temperature. The reduction in temperature differential between the first stream 28 and the second stream 32 also increases the controllability of the system 1 to achieve the desired dispensing temperature since the enthalpy of the two streams (i.e., the first stream 28 and the second stream 32) are more similar during mixing (i.e., at the time/location of mixing/recombining) and therefore less sensitive to changes in rate of flow therebetween.

Depending on ambient temperatures and other requirements of the system 1 and/or circumstances, there may be a variable rate of flow (e.g., volume of fuel flowing through a given cross sectional area per unit of time) between the first stream 28 flowing (e.g., via a conduit) along the first flow path 30 and the second stream 32 flowing (e.g., via a conduit) along the second flow path 34. For example, ambient temperatures may demand that a higher or lower volume of the fuel 4 be pumped along the first flow path 30 relative to the fuel 4 pumped along the second flow path 34 (i.e., that a higher or lower volume of the fuel 4 from the first stream 28 be mixed relative to the fuel 4 from the second stream 32) to achieve the desired dispensing temperature, or vice versa.

To account for rapid process changes in temperature and pressure which may create variable rates of flow, a buffer tank 56 having a reservoir (not shown) for receiving, storing, and/or controllably releasing fuel 4 may be employed in the system 1. The buffer tank 56 may be coupled to a controller(s) 50, 51 (described in more detail below) and/or a pump (e.g., the pump 2), and may be located in the first flow path 30, preferably downstream from the second vaporizer 28, as shown in FIGS. 1-3. When the system 1 and/or operator detects/signals (e.g., from a sensor) a higher rate of flow or temperature of the first stream 28 relative to the second stream 32, such that the fuel 4 from the first stream 28 and the second stream 32 would predictably mix to an undesirably high temperature, the buffer tank 56 may be configured to receive and store excess process fuel 4 from the first stream 28 in the reservoir. When the system 1 and/or operator detects/signals (e.g., from a sensor) a lower rate of flow or temperature of the first stream 28 relative to the second stream 32, such that the fuel 4 from the first stream 28 and the second stream 32 would predictably mix to an undesirably low temperature, the buffer tank 56 may be configured to controllably release (e.g., via a pump) fuel 4 from the reservoir into the first flow path 30 (i.e., into the first stream 28). In this way, the buffer tank 56 permits the system 1 to trim process temperatures which are undesirably high or low based on a variety of conditions without the need for an additional cooling loop which may require additional equipment and/or the use of refrigerants, as in the prior art.

For example, where the demand at the at least one dispenser 52 is lower than a lowest rate of flow that can be provided by the pump 2, the buffer tank 56 may receive the excess fuel 4 which cannot readily be dispensed to prevent the excess fuel 4 from being vented into the atmosphere and lost. The excess fuel 4 may then be reintroduced into the first stream 28 when the demand at the at least one dispenser 52 is higher. In addition to trimming process temperatures, this function of the buffer tank 56 permits the system 1 to remain on for longer periods when the demand for the fuel 4 is low.

Any of the control valve(s) 40, the control valve(s) 240, the control valve 342, the orifice(s) 344, and/or the manifold 444 may be coupled to a temperature sensor 46 (e.g., a temperature transducer), flow meter(s) 48, and/or the controller(s) 50, 51, respectively, as can be seen in FIGS. 1-3. Whether the control valve(s) 40, the control valve(s) 240, the control valve 342, the orifice(s) 344, and/or the manifold 444 are coupled to any of the temperature sensor 46 (e.g., a temperature transducer), the flow meter(s) 48, and/or the controller(s) 50, 51 may depend on a case-by-case basis on the individual requirements of the system 1. Note that in FIGS. 1-3, at least the control valve(s) 40, the control valve(s) 240, the control valve 342, the orifice(s) 344, and/or the manifold 444, the temperature sensor 46 (e.g., temperature transducer), and/or the flow meter(s) 48 may be located in warmer (non-cryogenic) streams which are downstream from the first temperature conditioning loop 3, allowing for a wide range of such components to be utilized which are not required to operate under cryogenic conditions and avoiding such extreme thermal cycles may reduce wear and tear which have the potential to weaken those components. Although one temperature sensor is described and depicted, multiple such sensors could be located in different portions of the system 1 (e.g., at different locations along various flow paths).

In an embodiment depicted in FIGS. 1-3, the temperature sensor 46 (e.g., temperature transducer) may be physically located in the terminal flow path 53, for example, downstream (i.e., in a direction from tank 6 toward the at least one dispenser 52) from the control valve(s) 40, the control valve(s) 240, the control valve 342, the orifice(s) 344, and/or the manifold 444. For example, the temperature sensor 46 may be located between the at least one dispenser 52 and any of the control valve(s) 40, the control valve(s) 240, the control valve 342, the orifice(s) 344, and/or the manifold 444. In some embodiments, the temperature sensor 46 (e.g., temperature transducer) may be coupled to the controller(s) 50, 51 to supply the controller(s) 50, 51 with temperature readings/information necessary to regulate the temperature and/or rate of flow of the fuel 4.

The controller(s) 50, 51 may be configured to perform aspects of the disclosed method autonomously (including semi-autonomously), with other aspects of the system 1 sharing information therewith. Specifically, the controller(s) 50, 51 may be configured to control and/or direct various aspects of the process and/or the system 1 described herein to, inter alia, modify and/or regulate the flow rate and/or the temperature of the fuel 4 as the fuel 4 proceeds through the system 1 (i.e., at various locations of the system 1 and during various aspects of the process), as described in more detail below. For example, the controller(s) 50, 51 may be coupled to the pump 2 to control the rate at which the fuel 4 is pumped through the system 1 or any part thereof. Notably, the controller 50 and the controller 51 may be the same controller, and in some embodiments (not depicted) there may be more controllers or less controllers. The controller(s) 50, 51 may be coupled to a variable frequency drive or a plurality of variable frequency drives. The control of variable frequency drive(s) by the controller(s) 50, 51 to drive components may allow the pump 2 and/or other components to continuously increase and decrease in speed when started, stopped, and/or during operation of the system 1. Use of variable frequency drives may therefore smooth power consumption and reduce overall peak power demand.

Variable frequency drives can also be manually adjusted to optimize motor speed for components such as the pump 2. The controller(s) 50, 51 may include a programmable logic controller (PLC) which may include a screen (e.g., a color touchscreen) and an interface for programming operational sequencing of various process steps and/or to permit manual regulation of the system 1, including ramping functions for variable frequency drives, pumpdown sequences, and maintenance and tuning modes. The controller(s) 50, 51 may be configured to monitor various aspects and, if the controller(s) 50, 51 detect operation outside of predetermined operating ranges, to take action to correct the process and/or to safeguard equipment and personnel, such as by modifying the operation of various aspects, shutting down the system, etc. The controller(s) 50, 51 may also connect to the internet to allow remote access to and monitoring of the system 1 during operation, and to provide notifications regarding system status and maintenance.

Alternatively, where the controller(s) 50, 51 is/are absent, an operator of the system 1 may perform those aspects manually which may otherwise be performed by the controller(s) 50, 51. The temperature sensor 46 (e.g., temperature transducer) and/or controller(s) 50, 51 may be coupled to various other components, including the one or more control valves 36, the control valve(s) 40, the control valve(s) 240, the control valve 342, the orifice(s) 344, the manifold 444, the flow meter 48, and/or the buffer tank 56 to permit regulating, measuring, recording, and/or monitoring of the temperature, rate of flow, and/or other metrics of the fuel 4 at various points during the process and/or at various locations in the system 1. For example, where the controller(s) 50, 51 are coupled to the one or more control valves 36, the controller(s) 50, 51 may permit regulation and/or modification to the ratio of the fuel 4 which is apportioned to the first flow path 30 relative to the second flow path 34.

The temperature sensor 46 (e.g., temperature transducer) may be configured with the controller(s) 50, 51 to record, monitor and/or measure the temperature of the target temperature fuel stream 54 at various points/times during the process and/or at various locations in the system 1 prior to dispensing the target temperature fuel stream 54 through the at least one dispenser 52. Thus, the temperature sensor 46 (e.g., temperature transducer) allows for an operator or the controller(s) 50, 51 to record, monitor and/or measure the temperature of the target fuel temperature stream 54 prior to dispensing to ensure the target fuel temperature stream 54 actually reaches the desired dispensing temperature, and permitting the operator and/or the controller(s) 51 to make adjustments to (i.e., regulate) the volumetric ratio of the fuel 4 passing through the control valve(s) 40, the control valve(s) 240, the control valve 342, the orifice(s) 344, and/or the manifold 444, or of fuel 4 being released from the reservoir of the buffer tank 56 to correct the undesired dispensing temperature to the desired dispensing temperature.

Where the temperature sensor 46 (e.g., temperature transducer) detects, predicts, projects, and/or indicates (i.e., signals) an undesired dispensing temperature that is colder than the desired dispensing temperature, one adjustment which may be made by the operator and/or the controller(s) 50, 51 is to increase the ratio of fuel 4 being mixed from the first stream 28 (i.e., the “warm” stream which has been warmed in the second vaporizer 38) as compared to the second stream 32 (i.e., the “intermediate temperature” stream which bypasses the second vaporizer 38). Increasing the ratio of fuel 4 being mixed from the first stream 28 (i.e., from the first flow path 30) as compared to the second stream 32 (i.e., from the second flow path 34) may be accomplished, for example, by adjusting the size of various openings in the control valve(s) the control valve(s) 240, the control valve 342, the orifice(s) 344, and/or the manifold 444 to permit a higher volume of fuel 4 from the first stream 28 (i.e., from the first flow path 30) to be mixed relative to the volume of fuel 4 from the second stream 32 (i.e., from the second flow path 34). Increasing the ratio of fuel 4 being mixed from the first stream 28 as compared to the second stream 32 may also be accomplished by controllably releasing excess fuel 4 from the reservoir of the buffer tank 56 into the first flow path 30 (i.e., into the first stream 28), such that more of the fuel 4 from the first stream 28 (i.e., from the first flow path 30) is able to pass through the control valve(s) 40, the control valve(s) 240, the control valve 342, the orifice(s) 344, and/or the manifold 444. To controllably release the excess fuel 4 from the reservoir, the buffer tank 56 may be coupled to the controller(s) 50, 51.

Where the temperature sensor 46 (e.g., temperature transducer) detects and/or indicates (i.e., signals) an undesired dispensing temperature that is warmer than the desired dispensing temperature, one adjustment which may be made by the operator and/or the controller(s) 50, 51 is to decrease the ratio of fuel 4 being mixed from the first stream 28 (i.e., the “warm” stream which has been warmed in the second vaporizer 38) as compared to the second stream 32 (i.e., the “intermediate temperature” stream which bypasses the second vaporizer 38). Decreasing the ratio of fuel 4 being mixed from the first stream 28 (i.e., from the first flow path as compared to the second stream 32 (i.e., from the second flow path 34) may be accomplished, for example, by adjusting the size of various openings in the control valve(s) 40, the control valve(s) 240, the control valve 342, the orifice(s) 344, and/or the manifold 444 to restrict the volume of fuel 4 from the first stream 28 (i.e., from the first flow path 30) being mixed relative to the volume of fuel 4 from the second stream 32 (i.e., from the second flow path 34). Decreasing the ratio of fuel 4 being mixed from the first stream 28 as compared to the second stream 32 may also be accomplished by storing excess fuel 4 from the first stream 28 (i.e., from the first flow path) in the reservoir of the buffer tank 56, such that less of the fuel 4 from the first stream 28 (i.e., from the first flow path 30) is able to pass through the control valve(s) 40, the control valve(s) 240, the control valve 342, the orifice(s) 344, and/or the manifold 444.

The flow meter 48 may be a single flow meter or a plurality of flow meters (i.e., two or more flow meters), as shown in FIGS. 1-3. As noted above, the flow meter 48 may be coupled to the controller(s) 50, 51 to permit monitoring, measuring, and/or recording of the rates of flow and/or a rate of discharge of the fuel 4 as it flows through and/or out of the system 1. In one embodiment, a first flow meter 58 of the flow meter 48 may be located in the first flow path 30, and a second flow meter 60 of the flow meter 48 may be located in the second flow path 34. Such a placement of the flow meter 48 at points downstream from the first temperature conditioning loop 3 (i.e., after the fuel 4 has been warmed to the intermediate temperature) allows for a wide range of parts to be utilized which are not required to operate under cryogenic conditions, providing an advantage to the system 100 with respect to reduced wear and tear on these parts due to avoiding extreme thermal cycles which have the potential to weaken those components. Alternatively, the flow meter 48 may also be located at other points in the system 1 depending on the system 1 requirements on a case-by-case basis.

The first flow meter 58 may be located downstream from both the second vaporizer 38 and the buffer tank 56, and upstream from the control valve(s) 40, the control valve(s) 240, the control valve 342, the orifice(s) 344, and/or the manifold 444; such a placement of the first flow meter 58 permits monitoring, measuring, and/or recording of the rates of flow and/or the rate of discharge of the fuel 4 in the first flow path 30 after it has been processed by the second vaporizer 38, and after any excess fuel 4 has been either received/stored in or controllably released from the reservoir of the buffer tank 56. Such a location of the first flow meter 58 may therefore be particularly beneficial by allowing for measuring, monitoring, and/or recording of the rates of flow and/or the rate of discharge of the fuel 4 at a point(s) in the system 1 at which the fuel 4 in the first stream 28 which may experience variance in the rate of flow and/or the rate of discharge relative to the fuel 4 in the second stream 32. Therefore, locating the first flow meter 58 as described may best allow for the operator or the computer controller(s) 50, 51 to detect changes in, make adjustments to, and/or regulate the system 1 to best achieve the desired fuel temperature. However, the flow meter 48 may be located at other points in the system 1, depending on the system 1 requirements on a case-by-case basis.

After the fuel 4 (i.e., the first stream 28 and the second stream 32) has been properly mixed (i.e., after the fuel 4 uniformly reaches the desired fuel temperature), such that the fuel 4 comprises the target temperature fuel stream 54, the fuel 4 (i.e., the target temperature fuel stream 54) may flow to at least one dispenser 52 where it may be dispensed. The at least one dispenser 52 may be a single dispenser or a plurality of dispensers. The fuel 4 (i.e., the target temperature fuel stream 54) may be dispensed from the at least one dispenser 52 to a vehicle (not shown), a plurality of vehicles, or another fuel storage container.

The flow scheme of the system 1 may be employed on mobile systems as well as on stationary filling designs. The components of the system 1 (including various conduits not shown which connect the components described above) may be either located near the at least one dispenser 52 or remotely away from the at least one dispenser 52 at the station depending on the requirements of the station and/or station layout on a case-by-case basis. Various piping and conduits may be used to connect and/or couple the various components of the system 1 described above. The flow scheme of the system 1 may be repeated (i.e., multiple of the system 1 running in parallel) to support the plurality of dispensers of the same type or different types. Alternatively, one large system (e.g., a scaled-up version of the system 1) may feed the plurality of dispensers. The system 1 may be applied to any range of desired dispensing temperatures, for example as mentioned above with respect to SAE J2601. The system 1 may be applied for any vehicle fueling pressure requirement per fueling protocol.

As described above, the systems and methods disclosed herein for mixing and dispensing fuel (e.g., hydrogen fuel) at controlled temperatures may be advantageous because the systems operate without the additional complexity and equipment necessary for a separate cooling loop, such as refrigerants, additional piping, storage containers, etc. Fundamentally, the systems and methods described are based on a direct heat exchange between different segments of a same process fluid stream (e.g., hydrogen, liquid nitrogen gas (“LNG”), or other process fluid(s)/gas(es)) that is ultimately dispensed for fueling without a need for external temperature control.

While several aspects have been described and depicted herein, alternative aspects may be affected by those skilled in the art to accomplish the same objectives. Accordingly, it is intended by the appended claims to cover all such alternative aspects as fall within the true spirit and scope of the disclosure.

1. A method for mixing and dispensing fuel comprising:
flowing cryogenic fuel from a storage tank through a cold portion of a process heat exchanger to a first vaporizer,
flowing the cryogenic fuel from the first vaporizer through a warm portion of the process heat exchanger to obtain an intermediate temperature fuel exiting the process heat exchanger,
separating the intermediate temperature fuel into a first stream and a second stream,
directing the first stream through a second vaporizer to obtain a warmed stream,
combining the warmed stream and the second stream to obtain a target fuel temperature stream, and
dispensing the target fuel temperature stream through at least one dispenser.

2. The method of claim 1, wherein the separating the intermediate temperature fuel into the first stream and the second stream comprises separating the intermediate temperature fuel by directing the intermediate temperature fuel through a control valve or a manifold, the control valve or the manifold connected to a first flow path and a second flow path.\

3. The method of claim 1, further comprising storing excess fuel in a buffer tank and regulating a temperature and/or a pressure of at least the first stream by controllably releasing the excess fuel from the buffer tank.

4. The method of claim 1, wherein the dispensing the target fuel temperature stream through the at least one dispenser includes dispensing the target temperature fuel stream to at least one vehicle.

5. The method of claim 1, wherein the separating the intermediate temperature fuel into the first stream and the second stream comprises separating the intermediate temperature fuel stream into the first stream having a first volume and the second stream having a second volume, wherein the first volume and the second volume comprise different volumes relative to each other.

6. The method of claim 5, wherein the separating the intermediate temperature fuel into the first stream and the second stream further comprises automatically adjusting a ratio of the first volume relative to the second volume based on a desired temperature of the target fuel temperature stream.

7. The method of claim 5, further comprising buffering changes in a temperature and/or a pressure of the warmed stream by controlling a flow of the fuel in the first flow path to and/or from a buffer tank.

8. The method of claim 1, wherein the separating the intermediate temperature fuel into the first stream and the second stream further comprises separating the intermediate temperature fuel into the first stream having a first volume and a second stream having a second volume, wherein the first volume and the second volume are equal.

9. The method of claim 1, wherein the directing the first stream through the second vaporizer to obtain the warmed stream further comprises warming the first stream to a temperature higher than a temperature of the intermediate temperature fuel and lower than an ambient temperature of ambient air to obtain the warmed stream.

10. A system for mixing and dispensing fuel, comprising:
a first temperature adjustment loop connected to a second temperature adjustment loop, the first temperature adjustment loop comprising:
a storage tank configured to hold a fuel,
a process heat exchanger located downstream from the storage tank and having a cold portion and a warm portion, and
a first vaporizer having an inlet and an outlet, the inlet connected to the cold portion of the process heat exchanger and the outlet connected to the warm portion of the process heat exchanger; and
the second temperature adjustment loop comprising:
a first flow path including a second vaporizer, and
a second flow path bypassing the second vaporizer, the first flow path and second flow path connected downstream to a third flow path, the third flow path connected to at least one dispenser.

11. The system of claim 10, wherein at least one flow meter is located in the first flow path and/or the second flow path at a location upstream of the third flow path.

12. The system of claim 10, further comprising a buffer tank containing a reservoir for receiving warm fluid, the buffer tank connected to the first flow path and configured to store an excess fuel generated from a variable flow of fuel between the first flow path and the second flow path.

13. The system of claim 12, wherein the buffer tank is further configured to release the excess fuel in response to a fluctuation in a volume of the fuel flowing through the first flow path relative to the second flow path, the fluctuation in volume resulting from the variable flow of fuel between the first flow path and the second flow path.

14. The system of claim 10, wherein the first temperature adjustment loop is connected to the second temperature adjustment loop by a control valve, a manifold, or a plurality of orifices for controlling a ratio of a first volume of the fuel flowing through the first flow path relative to a second volume of the fuel flowing through the second flow path.

15. The system of claim 14, wherein the control valve or the manifold is connected to a controller and a temperature sensor, the controller configured to automatically regulate the first volume and/or the second volume based on a desired temperature of the fuel and/or an ambient temperature of ambient air located outside of the system.

16. The system of claim 10, further comprising a mixing valve having a first opening, a second opening, and a third opening, the first opening coupled to the first flow path, the second opening coupled to the second flow path, and the third opening coupled to the third flow path.

17. The system of claim 16, further comprising a temperature sensor located between the mixing valve and the at least one dispenser, wherein the temperature sensor is coupled to the mixing valve or to at least one control valve upstream from a mixing point to permit control over the ratio of the fuel from the first flow path mixed with the fuel from the second flow path based on a temperature reading of the fuel in the first flow path relative to the fuel in the second flow path.

18. The system of claim 10, wherein the first vaporizer and/or the second vaporizer comprises a natural draft heat exchanger, a forced draft heat exchanger, a steam or hot water heater water bath vaporizer, a natural gas direct fired water bath vaporizer, an electricity heat vaporizer, or an electric heater water bath vaporizer.

19. A system for mixing and dispensing fuel, comprising:
a first temperature adjustment loop connected to a second temperature adjustment loop, the first temperature adjustment loop comprising:
a storage tank configured to hold a fuel,
a process heat exchanger having a cold portion and a warm portion,
a pump coupled to the storage tank and configured to pump fuel from the storage tank to the cold portion of the process heat exchanger,
the cold portion of the process heat exchanger connected to an inlet of a first vaporizer, and the warm portion of the process heat exchanger connected to an outlet of the first vaporizer, the fuel passing from the cold portion of the process heat exchanger to the inlet of the first vaporizer, through the first vaporizer, and from the outlet of the first vaporizer to the warm portion of the process heat exchanger; and
the second temperature adjustment loop comprising:
a control valve having a passage, the passage having a first opening and a second opening, the first opening coupled to the warm portion of the process heat exchanger and the second opening coupled to a first flow path and a second flow path, the control valve configured to separate the fuel received from the process heat exchanger into a first stream and a second stream, the control valve controllably permitting fuel from the first temperature adjustment loop to enter the second temperature adjustment loop,
the first flow path including a second vaporizer, and
the second flow path bypassing the second vaporizer,
the first flow path and the second flow path connected to a mixing valve, the mixing valve located upstream from at least one dispenser,
the mixing valve configured to receive and mix the fuel from the first flow path and the second flow path, and
the dispenser configured to receive and dispense the fuel after the fuel has been mixed.
